(19) United States
(12) Patent Application Publication
(10) Pub. No.: US 2003/0003919 A1
(43) Pub. Date: Jan. 2, 2003

(54) Relocation of serving network radio network controller ( SRNC) which has used direct transport bearers between SRNC and base station

(76) Inventors: Per Beming, Stockholm (SE); Gert-Jan Van Lieshout, Apeldoorn (NL)

Correspondence Address: NIXON & VANDERHYE P.C., 1100 North Glebe Road, 8th Floor, Arlington, VA, 22201, US

(21) Appl. No.: 10/078,161

(22) Filed: Feb. 20, 2002

Related U.S. Application Data
(60) Provisional application No. 60/301,431, filed on Jun. 29, 2001.

(51) Int. Cl. H04Q 7/20

(52) U.S. Cl. 455/446; 455/561

(57) ABSTRACT

Existing control plane protocol procedure(s) are employed to provide a SRNS relocation procedure to relocate a SRNS function from a source radio network controller (26₁) to a target radio network controller (26₂), even though a direct transport bearer (100) had previously been used between the source radio network controller and the Node-B. In example implementations, the existing control plane protocol procedure includes at least one of a NBAP procedure and a RNSAP procedure. In one mode of the invention, performance of the SRNS relocation procedure comprises a relocation request communicating step; a new transport bearer establishing step; a relocation triggering step; and a bearer switching step. In the relocation request communication step, the target radio network controller is notified that a relocation of the SRNS function is requested. In the new transport bearer establishing step, a new transport bearer is established between the target radio network controller and the Node-B. In the relocation triggering step, a relocation execution trigger message is sent from the source radio network controller to the target radio network controller. In the bearer switching step, a switch occurs from the direct transport bearer to the new transport bearer.

This application claims the priority and benefit of U.S. Provisional patent application No. 60/301,431, filed Jun. 29, 2001, which is incorporated herein by reference in its entirety.

### BACKGROUND

1. Field of the Invention

The present invention pertains to wireless telecommunications, and particularly to performing a relocation of a serving radio network controller (SRNC) role in a UMTS network, when prior to the relocation the SRNC has been using direct transport bearers to a base station (e.g., Node-B) controlled by a drift radio network controller (DRNC).

2. Related Art and Other Considerations

In a typical cellular radio system, mobile user equipment units (UEs) communicate via a radio access network (RAN) to one or more core networks. The user equipment units (UEs) can be mobile stations such as mobile telephones (“cellular” telephones) and laptops with mobile termination, and thus can be, for example, portable, pocket, hand-held, computer-included, or car-mounted mobile devices which communicate voice and/or data with radio access network.

The radio access network (RAN) covers a geographical area which is divided into cell areas, with each cell area being served by base station (BS). A cell is a geographical area where radio coverage is provided by the radio base station equipment at a base station site. Each cell is identified by a unique identity, which is broadcast in the cell. The base stations communicate over the air interface (e.g., radio frequencies) with the user equipment units (UE) within range of the base stations. In the radio access network, several base stations are typically connected (e.g., by landlines or microwave) to a radio network controller (RNC). The radio network controller, also sometimes termed a base station controller (BSC), supervises and coordinates various activities of the plural base stations connected thereto. The radio network controllers are typically connected to one or more core networks.

One example of a radio access network is the Universal Mobile Telecommunications (UMTS) Terrestrial Radio Access Network (UTRAN). The UMTS is a third generation system which in some respects builds upon the radio access technology known as Global System for Mobile communications (GSM) developed in Europe. UTRAN is essentially a radio access network providing wideband code division multiple access (WCDMA) to user equipment units (UEs). The Third Generation Partnership Project (3GPP) has undertaken to evolve further the UTRAN and GSM-based radio access network technologies.

As those skilled in the art appreciate, in W-CDMA technology a common frequency band allows simultaneous communication between a user equipment unit (UE) and plural base stations. Signals occupying the common frequency band are discriminated at the receiving station through spread spectrum CDMA waveform properties based on the use of a high speed, pseudo-noise (PN) code. These high speed PN codes are used to modulate signals transmitted from the base stations and the user equipment units (UEs). Transmitter stations using different PN codes (or a PN code offset in time) produce signals that can be separately demodulated at a receiving station. The high speed PN modulation also allows the receiving station to advantageously generate a received signal from a single transmitting station by combining several distinct propagation paths of the transmitted signal. In CDMA, therefore, a user equipment unit (UE) need not switch frequency when handoff of a connection is made from one cell to another. As a result, a destination cell can support a connection to a user equipment unit (UE) at the same time the origination cell continues to service the connection. Since the user equipment unit (UE) is always communicating through at least one cell during handover, there is no disruption to the call. Hence, the term “soft handover.” In contrast to hard handover, soft handover is a “make-before-break” switching operation.

The Universal Mobile Telecommunications (UMTS) Terrestrial Radio Access Network (UTRAN) accommodates both circuit switched and packet switched connections. In this regard, in UTRAN the circuit switched connections involve a radio network controller (RNC) communicating with a mobile switching center (MSC), which in turn is connected to a connection-oriented, external core network, which may be (for example) the Public Switched Telephone Network (PSTN) and/or the Integrated Services Digital Network (ISDN). On the other hand, in UTRAN the packet switched connections involve the radio network controller communicating with a Serving GPRS Support Node (SGSN) which in turn is connected through a backbone network and a Gateway GPRS support node (GGSN) to packet-switched networks (e.g., the Internet, X.25 external networks). MSCs and GSNs are in contact with a Home Location Register (HRL), which is a database of subscriber information.

There are several interfaces of interest in the UTRAN. The interface between the radio network controllers (RNCs) and the core network(s) is termed the “Iu” interface. The interface between a radio network controller (RNC) and its base stations (BSs) is termed the “Iub” interface. The interface between the user equipment unit (UE) and the base stations is known as the “air interface” or the “radio interface” or “Uu interface”. In some instances, a connection involves both a Serving or Source RNC (SRNC) and a target or drift RNC (DRNC), with the SRNC controlling the connection but with one or more diversity legs of the connection being handling by the DRNC. An Inter-RNC transport link can be utilized for the transport of control and data signals between Source RNC and a Drift or Target RNC, and can be either a direct link or a logical link as described. An interface between radio network controllers (e.g., between a Serving RNC [SRNC] and a Drift RNC [DRNC]) is termed the “Iur” interface

Those skilled in the art appreciate that, with respect to a certain RAN-UE connection, an RNC can either have the role of a serving RNC (SRNC) or the role of a drift RNC (DRNC). If an RNC is a serving RNC (SRNC), the RNC is in charge of the connection with the user equipment unit (UE), e.g., it has full control of the connection within the radio access network (RAN). A serving RNC (SRNC) is connected to the core network. On the other hand, if an RNC is a drift RNC (DRNC), its supports the serving RNC (SRNC) by supplying radio resources (within the cells controlled by the drift RNC (DRNC)) needed for a connection with the user equipment unit (UE). A system which includes the drift radio network controller (DRNC) and the base stations controlled over the Iub Interface by the drift radio network controller (DRNC) is herein referenced as a DRNC subsystem or DRNS.

When a radio connection between the radio access network (RAN) and user equipment unit (UE) is being established, the radio access network (RAN) decides which RNC is to be the serving RNC (SRNC) and, if needed, which RNC is to be a drift RNC (DRNC). Normally, the RNC that controls the cell where the user equipment unit (UE) is located when the radio connection is first established is initially selected as the serving RNC (SRNC). As the user equipment unit (UE) moves, the radio connection is maintained even though the user equipment unit (UE) may move into a new cell, possibly even a new cell controlled by another RNC. That other RNC becomes a drift RNCs (DRNC) for RAN-UE connection. At any moment in time, the SRNC terminates at the UTRAN side the Iu interface over which all information for a specific user equipment unit (UE) is transported between the core network(s) and the UTRAN.

An RNC is said to be the Controlling RNC (CRNC) for the base stations connected to it by an Iub interface. This CRNC role is not UE specific. The CRNC is, among other things, responsible for handling radio resource management for the cells in the base stations connected to it by the Iub interface.

In certain situations it its advantageous to transfer control of a particular UE connection from one RNC to another RNC. Such a transfer of control of the UE connection from one RNC to another RNC has been referred to as soft RNC handover, SRNC moveover, and SRNC relocation. A relocate function/procedure is provided to effect this transfer of control. This is a general function/procedure covering UMTS internal relocations (e.g., relocation of SRNC within the UMTS) as well as relocations to other systems (e.g., from UMTS to GSM, for example).

In 3GPP specifications, moving the UTRAN-to-core network (CN) connection point at the UTRAN side for one specific UE from one RNC (source RNC) to another RNC (target RNC) is generally denoted by the term “SRNS relocation”. The 3GPP Technical Specification TS 23.060 describes three different SRNS relocation cases: (1) Serving SRNS relocation procedure; (2) Combined Hard Handover and SRNS Relocation procedure; and (3) Combined Cell/URA Update and SRNS Relocation Procedure.

SRNC relocation is also described, at least to some extent, in various references, including the following example commonly assigned patent applications (all of which are incorporated herein by reference):

(1) U.S. patent application Ser. No. 09/035,821 filed Mar. 6, 1998, entitled “Telecommunications Inter-Exchange Measurement Transfer”;

(2) U.S. patent application Ser. No. 09/035,788 filed Mar. 6, 1998, entitled “Telecommunications Inter-Exchange Congestion Control”;

(3) U.S. patent application Ser. No. 08/979,866 filed Nov. 26, 1997, entitled “Multistage Diversity Handling For CDMA Mobile Telecommunications”;

(4) U.S. patent application Ser. No. 08/980,013 filed Nov. 26, 1997, entitled “Diversity Handling Moveover For CDMA Mobile Telecommunications”;

(5) U.S. patent application Ser. No. 09/732,877 filed Dec. 11, 2000, entitled “Control Node Handover In Radio Access Network”;

(6) U.S. patent application Ser. No. 09/543,536 filed Apr. 5, 2000, entitled “Relocation of Serving Radio Network Controller With Signaling of Linking of Dedicated Transport Channels”;

(7) U.S. patent application Ser. No. 09/829,001 filed Apr. 10, 2001, entitled “Connection Handling in SRNC Relocation”.

SRNC relocation is intended to make more efficient use of the transmission network. Once the former SRNC is not needed, the connection to the core network is moved and the connection between the two RNCs (the former SRNC and the former DRNC over the Inter-RNC link) is disconnected.

The UTRAN interfaces (Iu, Iur and Iub) have two planes, namely, a control plane (CP) and a user plane (UP). In order to control the UTRAN, the radio network application in the different nodes communicate by using the control plane protocols. The RANAP is a control plane protocol for the Iu interface; the RNSAP is a control plane protocol for the Iur interface; and NBAP is a control plane protocol for the Iub interface. The RANAP protocol is described in UTRAN Iu Interface RANAP Signaling, 3GPP TSG-RAN3 25.413 v.3.7.0. The RNSAP protocol is described in UTRAN Iu Interface RNSAP Signaling, 3GPP TSG-RAN3 25.423 v.3.7.0. The NBAP protocol is described in UTRAN Iub Interface BNAP Signaling, 3GPP TSG-RAN3 25.433 v.3.7.0. See, also, for the UTRAN generally, UTRAN Overall Description, 3GPP TSG-RAN3 25.401.

The control plane protocols are transported over reliable signaling bearers. The transport of data received/transmitted on the radio interface occurs in the user plane (UP). In the user plane, the data is transported over unreliable transport bearers. The serving radio network controller (SRNC) is responsible for establishing the necessary transport bearers between the serving radio network controller (SRNC) and the drift radio network controller (DRNC).

The NBAP protocol (the control plane protocol for the Iub interface) includes NBAP synchronised RL-reconfiguration-preparation and RL-commit procedures. The RL-reconfiguration procedures are typically intended to be used for reconfiguration of characteristics of a Radio Link over the Uu interface towards a UE. In those cases where the capacity of the Radio Link needs to be increased, e.g., because a certain service needs additional bandwidth on the Uu and Iub interfaces, the RL-reconfiguration procedure can also modify the bandwidth of existing transport bearers used on the Iub and Iur interfaces, or replace existing transport bearers by new transport bearers with e.g. more/less bandwidth. NBAP/RNSAP specifications do not mandate a change in any radio link parameters when replacing a transport bearer, although replacement of the transport bearer will typically be required due to a change in RL characteristics.

A situation prior to Serving SRNS relocation, in accordance with the GPRS Service Description, 3GPP TSG-SA 23.060 v. 3.7.0, is shown in FIG. 1A. The transport of information between SRNC and a Node-B (under a Drift RNC) is provided via the DRNC and uses a concatenation of two separate transport bearers: a first transport bearer between SRNC and DRNC and a second transport bearer between the DRNC and the Node-B under its control. The SRNS relocation occurs, supported by a message sequence described in GPRS Service Description, 3GPP TSG-SA 23.060 v. 3.7.0, so that the situation depicted in FIG. 1B results. In the SRNC relocation the former drift RNC (DRNC) becomes a target RNC. In the particular situations shown in FIG. 1A and FIG. 1B, the Node-B is communicating with the DRNC both before and after the SRNS relocation. Apart from very limited signaling (e.g., RNTI reallocation and routing area update signaling), the user equipment unit (UE) is essentially not involved in the SRNS relocation scenario.

Thus, an example SRNC relocation is illustrated with reference to FIG. 1A and FIG. 1B. The example is non-constraining and merely illustrative, as variations can occur. For example, it is not necessary to utilize a new SGSN and a new MSC, as the same SGSN and same MSC can be utilized.

The use of a direct transport bearer has been proposed between an SRNC and a Node-B (the Node-B being under control of a DRNC). An advantage of a direct transport bearer is short circuiting the DRNC, thereby decreasing transport delay between the SRNC and the Node-B. This advantage occurs, at least in part, in that the direct transport bearer may utilize a more optimal route between the SRNC and the Node-B, and because the direct transport bearer need not be terminated in the DRNC. However, employment of a direct transport bearer is problematic when contemplating a SRNS relocation. In view of use of the direct transport bearer, the target RNC cannot “take over” the communication with the Node-B as in a normal SRNS relocation procedure.

What is needed, therefore, and an object of the present invention, is a technique for facilitating SRNS relocation even when a direct transport bearer has been employed between the SRNS and a Node-B under control of the target RNC (e.g., DRNC).

### BRIEF SUMMARY

Existing control plane protocol procedure(s) are employed to provide a SRNS relocation procedure to relocate a SRNS function from a source radio network controller to a target radio network controller, even though a direct transport bearer had previously been used between the source radio network controller and the Node-B. In the example non-limiting implementations, the existing control plane protocol procedure includes at least one of a NBAP procedure and a RNSAP procedure.

In one mode of the invention, performance of the SRNS relocation procedure comprises a relocation request communicating step; a new transport bearer establishing step; a relocation triggering step; and a bearer switching step. In the relocation request communication step, the target radio network controller is notified that a relocation of the SRNS function is requested. In the new transport bearer establishing step, a new transport bearer is established between the target radio network controller and the Node-B. In the relocation triggering step, a relocation execution trigger message is sent from the source radio network controller to the target radio network controller. In the bearer switching step, a switch occurs from the old (direct) transport bearer to the new transport bearer.

In an example implementation, the new bearer establishing step and the bearer switching step employ aspects of one or more radio link reconfiguration procedures. For example, the radio link reconfiguration procedure can be a NBAP synchronized radio link reconfiguration preparation procedure. The relocation execution trigger can be a RNSAP relocation commit message. In one example implementation, performing the bearer switching step can include using a synchronized radio link reconfiguration commit procedure to make the Node-B switch over to the new transport bearer.

In another example implementation, the new transport bearer can be established after the triggering step, with the new transport bearer establishing step and the bearer switching step together involving performing a NBAP synchronized radio link reconfiguration procedure; establishing a new transport bearer; and performing a NBAP synchronized radio link reconfiguration commit procedure.

In other example implementations, a NBAP unsynchronized radio link reconfiguration procedure can be utilized. For example, the NBAP unsynchronized radio link reconfiguration procedure can be performed prior to the relocation triggering. Alternatively, the unsynchronized radio link reconfiguration procedure can be performed (along with the establishing of the new transport bearer) subsequent to the relocation triggering.

In yet another example implementation, the new transport bearer can be established by performing one of a NBAP radio link setup procedure and a NBAP radio link addition procedure, after which a user equipment unit (UE) hard handover is performed for bearer switching.

In one of its aspects, the invention also encompasses transmitting a trigger value to Node-B to indicate to Node-B when the switching from the direct transport bearer to the new transport bearer is to occur. In one example embodiment, the trigger value is a connection frame number (CFN) which denotes a specific frame at a radio interface. Alternatively, in another embodiment, the target radio network controller can indicate to Node-B that the switching from the direct transport bearer to the new transport bearer is to occur as soon as possible. Such “as soon as possible” indication can be provided, for example, by absence of a trigger value. As another alternative, another event at the Node-B, e.g., receiving a data frame before LTOA (last time of arrival) can trigger the switching of the transport bearer.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1A is diagrammatic view of a network situation prior to Serving SRNS relocation in a scenario using two separate transport bearers, and with Node-B communicating with a DRNC before the Serving SRNS relocation.

FIG. 1B is diagrammatic view of the network situation of FIG. 1A subsequent to Serving SRNS relocation.

FIG. 2A is diagrammatic view of example mobile communications system in which the present invention may be advantageously employed, prior to SRNS relocation.

FIG. 2B is diagrammatic view of example mobile communications system of FIG. 2B subsequent to SRNS relocation.

FIG. 3 is a simplified function block diagram of a portion of a UMTS Terrestrial Radio Access Network, including a user equipment unit (UE) station; a radio network controller; and a node-B.

FIG. 4 is diagrammatic view showing various messages and procedures employed in a generic SRNS relocation procedure according to the invention.

FIG. 5 is a diagrammatic view showing a relationship between FIG. 5A and FIG. 5B.

FIG. 5A and FIG. 5B are diagrammatic views showing various messages and procedures employed in a first example, non-limiting of a SRNS relocation procedure according to the invention.

FIG. 6 is a diagrammatic view showing a relationship between FIG. 6A and FIG. 6B.

FIG. 6A and FIG. 6B are diagrammatic views showing various messages and procedures employed in a second example, non-limiting of a SRNS relocation procedure according to the invention.

FIG. 7 is a diagrammatic view showing a relationship between FIG. 7A and FIG. 7B.

FIG. 7A and FIG. 7B are diagrammatic views showing various messages and procedures employed in a third example, non-limiting of a SRNS relocation procedure according to the invention.

FIG. 8 is a diagrammatic view showing a relationship between FIG. 8A and FIG. 8B.

FIG. 8A and FIG. 8B are diagrammatic views showing various messages and procedures employed in a fourth example, non-limiting of a SRNS relocation procedure according to the invention.

FIG. 9 is a diagrammatic view showing a relationship between FIG. 9A and FIG. 9B.

FIG. 9A, FIG. 9B, and FIG. 9C are diagrammatic views showing various messages and procedures employed in a fifth example, non-limiting of a SRNS relocation procedure according to the invention.

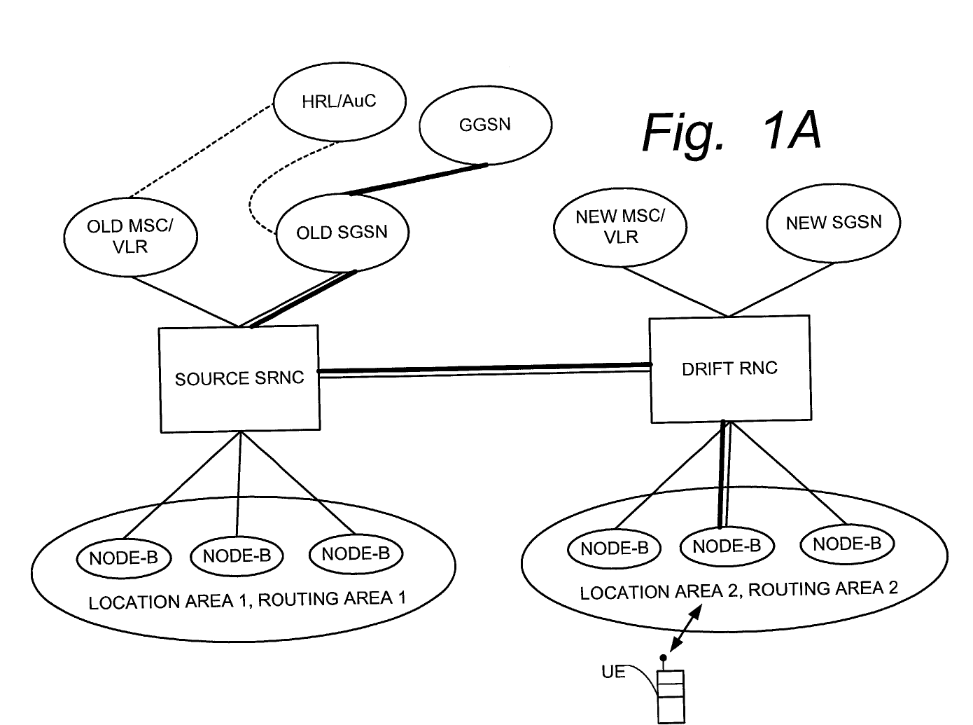

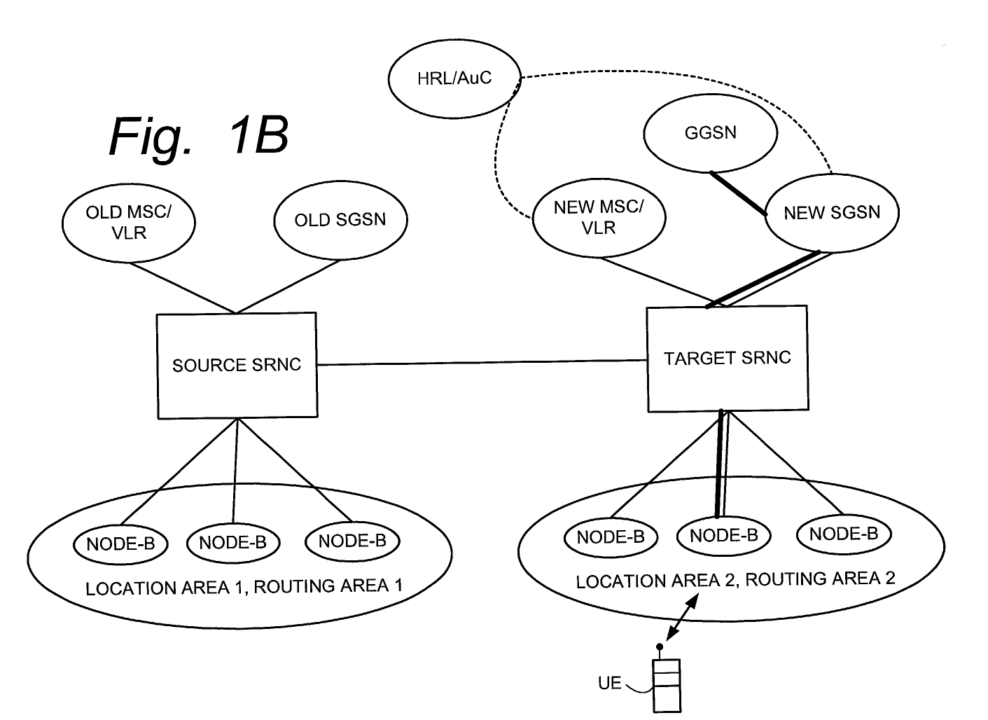

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

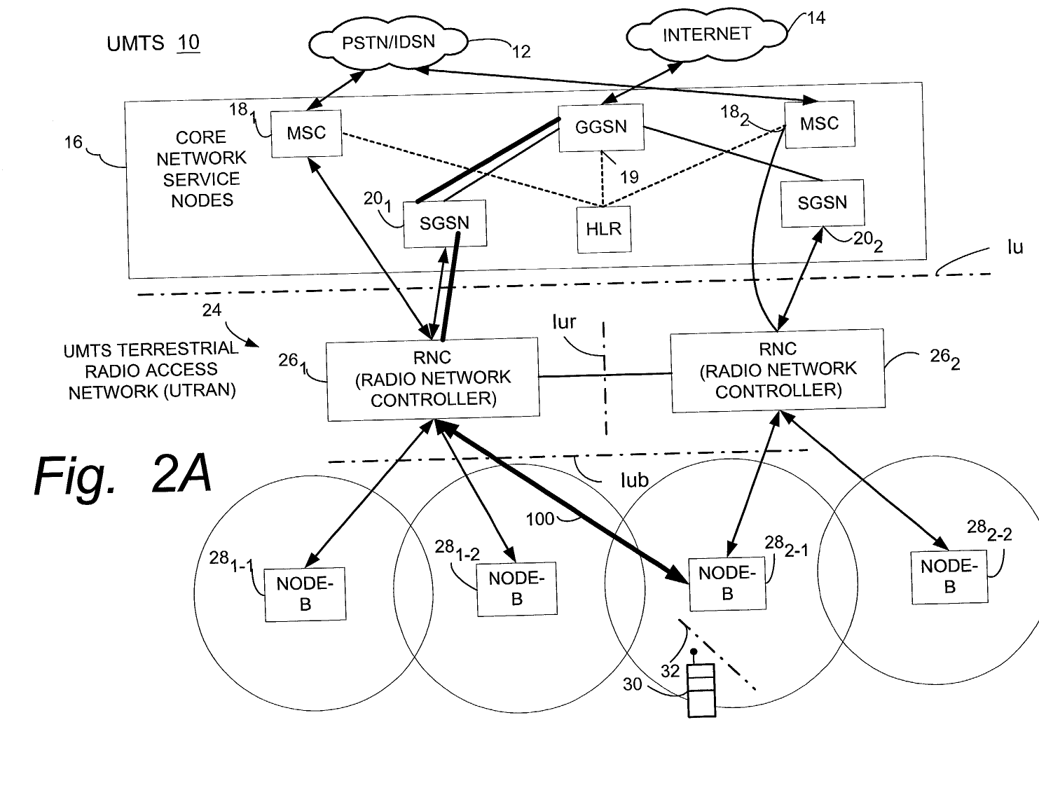

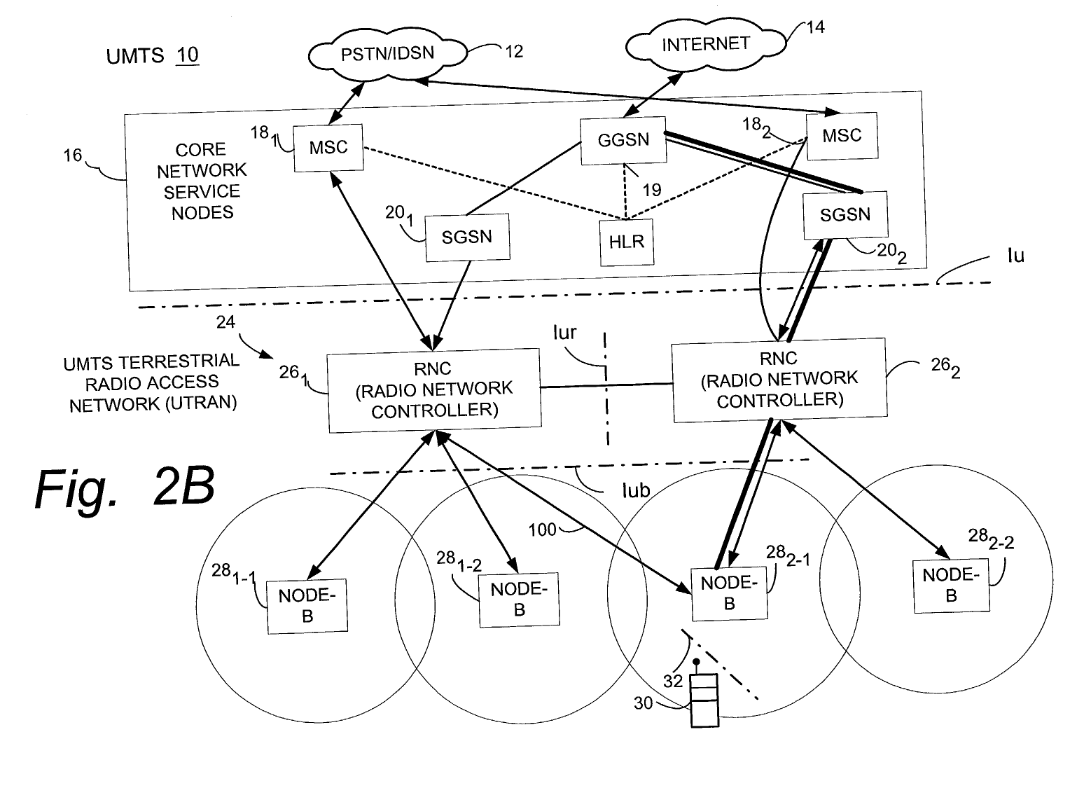

The present invention is described in the non-limiting, example context of a universal mobile telecommunications (UMTS) 10 shown in FIG. 2A. A representative, connection-oriented, external core network, shown as a cloud 12 may be for example the Public Switched Telephone Network (PSTN) and/or the Integrated Services Digital Network (ISDN). A representative, connectionless-oriented external core network shown as a cloud 14, may be for example the Internet. Both core networks are coupled to their corresponding service nodes 16. The PSTN/ISDN connection-oriented network 12 is connected to connection-oriented service nodes shown as a Mobile Switching Center (MSC) nodes 18 that provide circuit-switched services. The Internet connectionless-oriented network 14 is connected via Gateway GRPS support node (GGSN) 19, which is in turn connected through a backbone network to Serving GPRS Support Nodes (SGSN) 20 The Serving GPRS Support Nodes (SGSN) 20 are also known as General Packet Radio Service (GPRS) nodes and are tailored to provide packet-switched type services.

Each of the core network service nodes 18 and 20 connects to a UMTS Terrestrial Radio Access Network (UTRAN) 24 over a radio access network (RAN) interface referred to as the Iu interface. UTRAN 24 includes one or more radio network controllers (RNCs) 26. For sake of simplicity, the UTRAN 24 of FIG. 2A is shown with only two RNC nodes, particularly RNC 26₁ and RNC 26₂. In the particular situation shown in FIG. 2A, radio network controller (RNC) 24₁ is connected through a control mobile switching center 26₁ to circuit-switched telephone networks (PSTN/ISDN) 28 as well as to Serving GPRS Support Node (SGSN) 20₁ (and then through a backbone network to Gateway GRPS support node (GGSN) 19 through which connection is made with packet-switched networks 14). Similarly, radio network controller (RNC) 24₂ is connected through a control mobile switching center 26₂ to circuit-switched telephone networks (PSTN/ISDN) 28, as well as to Serving GPRS Support Node (SGSN) 20₂ (and then through a backbone network to Gateway GRPS support node (GGSN) 19 through which connection is made with packet-switched networks 14).

Each RNC 26 is connected to a plurality of base stations (BS) 28, also known as Node-Bs. For example, and again for sake of simplicity, two node-B nodes are shown connected to each RNC 26. In this regard, RNC 26₁ serves node-B 28₁₋₁ and node-B 28₁₋₂, while RNC 26₂ serves node-B 28₂₋₁ and node-B 28₂₋₂. It will be appreciated that a different number of node-Bs can be served by each RNC, and that RNCs need not serve the same number of node-Bs. Moreover, FIG. 2A shows that an RNC can be connected over an Iur interface to one or more other RNCs in the URAN 24. Further, those skilled in the art will also appreciate that a base station is sometimes also referred to in the art as a radio base station, a node-B, or B-node.

In the illustrated embodiments, for sake of simplicity each node-B 28 is shown as serving one cell. Each cell is represented by a circle which surrounds the respective node-B. It will be appreciated by those skilled in the art, however, that a node-B may serve for communicating across the air interface for more than one cell. For example, two cells may utilize resources situated at the same node-B site. Moreover, each cell may be divided into one or more sectors, with each sector having one or more cell carriers.

A user equipment unit (UE), such as user equipment unit (UE) 30 shown in FIG. 2A, communicates with one or more cells or one or more node-Bs 28 over a radio or air interface 32 (also known as the Uu interface). Each of the radio interface 32, the Iu interface, the Iub interface, and the Iur interface are shown by dash-dotted lines in FIG. 2A.

Preferably, radio access is based upon wideband, Code Division Multiple Access (WCDMA) with individual radio channels allocated using CDMA spreading codes. Of course, other access methods may be employed. WCDMA provides wide bandwidth for multimedia services and other high transmission rate demands as well as robust features like diversity handoff and RAKE receivers to ensure high quality.

Each user mobile station or equipment unit (UE) 30 is assigned its own scrambling code in order for a node-B 28 to identify transmissions from that particular user equipment unit (UE) as well as for the user equipment unit (UE) to identify transmissions from the node-B intended for that user equipment unit (UE) from all of the other transmissions and noise present in the same area.

Different types of control channels may exist between one of the node-Bs 28 and user equipment units (UEs) 30. For example, in the forward or downlink direction, there are several types of broadcast channels including a general broadcast channel (BCH), a paging channel (PCH), a common pilot channel (CPICH), and a forward access channel (FACH) for providing various other types of control messages to user equipment units (UEs). In the reverse or uplink direction, a random access channel (RACH) is employed by user equipment units (UEs) whenever access is desired to perform location registration, call origination, page response, and other types of access operations. The random access channel (RACH) is also used for carrying short data packets, such as web page requests in a web browser application, for example.

As set up by the control channels, traffic channels (TCH) are allocated to carry substantive call communications with a user equipment unit (UE). Some of the traffic channels can be common traffic channels, while others of the traffic channels can be dedicated traffic channels (DCHs).

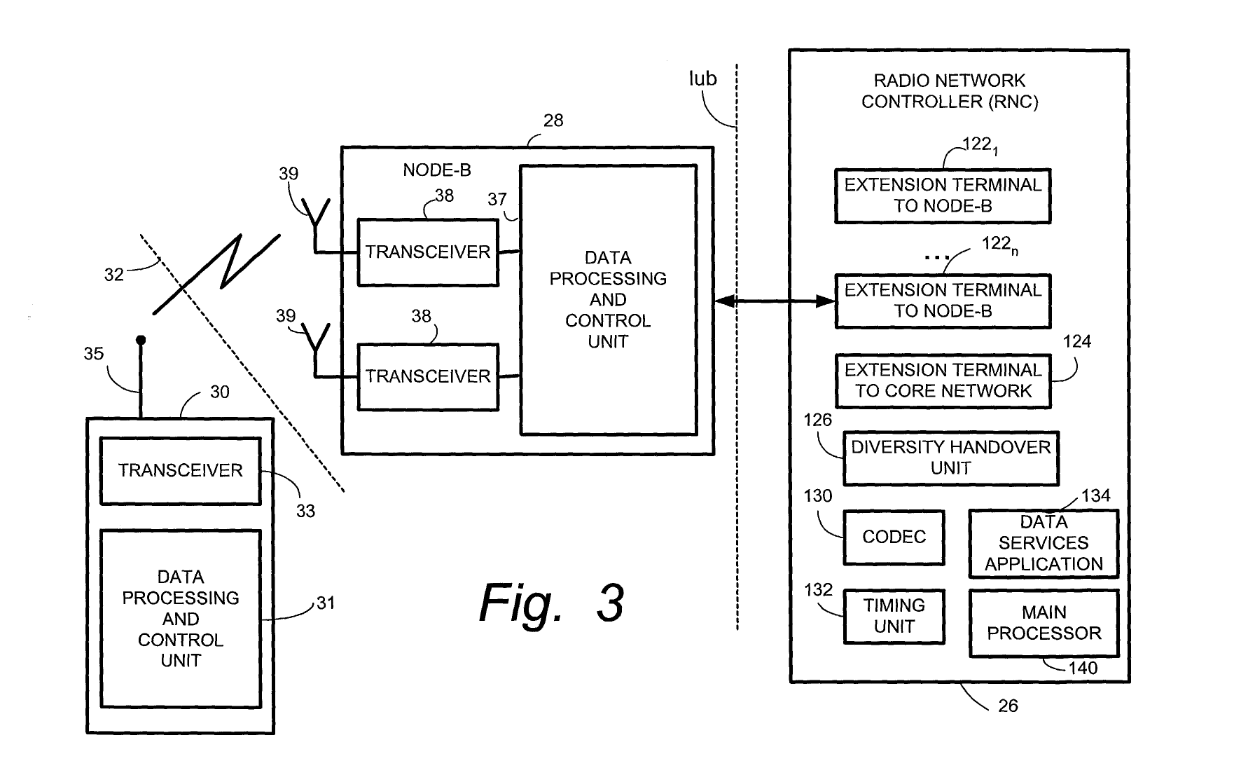

FIG. 3 shows selected general aspects of user equipment unit (UE) 30 and illustrative nodes such as radio network controller 26 and node-B 28. The user equipment unit (UE) 30 shown in FIG. 3 includes a data processing and control unit 31 for controlling various operations required by the user equipment unit (UE). The UE's data processing and control unit 31 provides control signals as well as data to a radio transceiver 33 connected to an antenna 35.

The example node-B 28 as shown in FIG. 3 includes a data processing and control unit 37 for performing numerous radio and data processing operations. Part of the equipment controlled by the node-B data processing and control unit 37 includes plural radio transceivers 38 connected to one or more antennas 39.

FIG. 3 also illustrates some constituent elements of an example, non-limiting RNC node 26 of the present invention. The illustrated constituent elements of RNC node 26 include extension terminals 122₁ through 122ₙ, as well as extension terminal 124. Extension terminals 122₁ through 122ₙ essentially function to connect RNC node 26 to the node-Bs 28 served by RNC node 26; extension terminal 124 connects RNC node 26 across the Iu interface to the core network. Yet other illustrated constituent elements of RNC node 26 include diversity handover unit 126; codec 130; timing unit 132; a data services application unit 134; and, a main processor 140.

At the time shown in FIG. 2A, the radio network controller (RNC) 26₁ is serving as a Serving RNC for a connection with user equipment unit (UE) 30. As such, the radio network controller (RNC) 26₁ has been controlling the legs of a connection with user equipment unit (UE) 30. One of the legs of the connection with user equipment unit (UE) 30 happens to utilize Node-B 28₂₋₁, which is controlled by radio network controller (RNC) 26₂. In the FIG. 2A scenario, radio network controller (RNC) 26₂ serves as a Drift RNC.

Significantly, for the particular scearnio shown in FIG. 2A, a direct transport bearer 100 is provided to connect Node-B 28₂₋₁ with radio network controller (RNC) 26₁ (which currently is serving as the SRNC for the connection with user equipment unit (UE) 30). FIG. 2A shows by heavy lines how the user data is routed through the core network and the UTRAN. The DRNC (radio network controller (RNC) 26₂) is essentially short-circuited, thereby decreasing transport delay between the SRNC (radio network controller (RNC) 26₁) and the Node-B 28₂₋₁.

The present invention solves the problem encountered when, in a situation such as FIG. 2A, a SRNS relocation is desired to move the role of the SRNC from the Source RNC (e.g., from radio network controller (RNC) 26₁) to a target RNC (e.g., radio network controller (RNC) 26₂). Initially such SRNS relocation would not seem feasible, since (in view of use of the direct transport bearer 100) the target RNC cannot “take over” the communication with the Node-B as in a normal SRNS relocation procedure. However, the present invention encompasses various scenarios in which, using (at least in part) existing protocol specifications, an SRNS relocation can be performed. In certain illustrated example embodiments, selected existing RANAP, RNSAP, and NBAP procedures, some optionally modified with adaptations/extensions as needed, faciliate SRNS relocation even in the case of direct transport bearers having been used between the Source SRNC and the Node-B.

As a result of performance of the SRNS relocation of the present invention, the serving radio network controller function/role previously performed by radio network controller (RNC) 26₁ is relocated to the target radio network controller (e.g., radio network controller (RNC) 26₂). After performance of the SRNS relocation, the user data is routed through the core network and the UTRAN as depicted by the heavy lines of FIG. 2B.

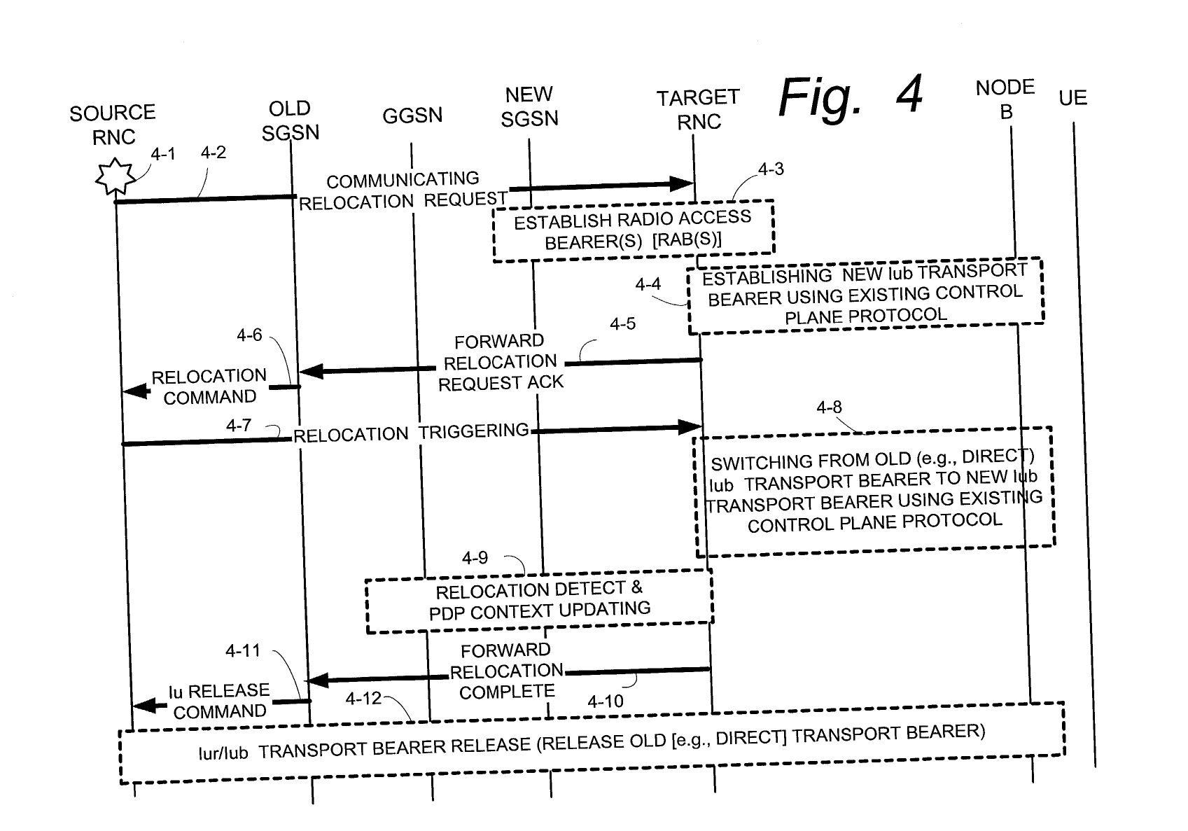

FIG. 4 shows certain basic events or steps involved in one example generic mode of the SRNS relocation method of the present invention. The SRNS relocation has the result of moving the SRNC role for the connection involving user equipment unit (UE) 30 from source radio network controller (RNC) 26₁ (the situation shown in FIG. 2A) to target radio network controller (RNC) 26₂ (the situation shown in FIG. 2B). Certain aspects of the generic mode of FIG. 4 are also understood with reference to the previously-listed patent applications, as well as U.S. patent application Ser. No. 09/843,034, filed Apr. 27, 2001, entitled “Efficient Header Handling Involving GSM/EDGE Radio Access Networks”, which is incorporated herein by reference.

FIG. 4 depicts, as event 4-1, a decision to perform the SRNS relocation. Typically such decision is performed by the source RNC (e.g., radio network controller (RNC) 26₁ in FIG. 2A). After the decision in favor of SRNS relocation has been made, one or more messages are sent (as event 4-2) for communicating the SRNS relocation request to the target radio network controller (e.g., to radio network controller (RNC) 26₂). Performance of event 4-2 is also known herein as the relocation request communicating step. In the relocation request communication step, a transparent container is transported from the Source RAN to the target RAN. This transparent container includes information about RRC protocol context, and notifies the target radio network controller that a relocation of the SRNS function has been requested.

Upon receipt of the SRNS relocation request, the target RNC allocates resources to establish radio access bearers (RABs), depicted as event 4-3 in FIG. 4.

FIG. 4 shows, as event 4-4, a procedure of establishing a new Iub transport bearer(s). The step of event 4-4 [e.g., of establishing a new Iub transport bearer(s)] is also referred to as new transport bearer establishing step. In this new transport bearer establishing step, a new transport bearer is established between the target radio network controller and the Node-B. The new Iub transport bearer(s) is established, according to the present invention, using existing control plane protocol(s).

After the new Iub transport bearer(s) have been established, a process (depicted as event 4-5 and 4-6) occurs whereby the old SGSN (e.g., Serving GPRS Support Nodes (SGSN) 20₁ in FIG. 2A) and the source RNC (e.g., radio network controller (RNC) 26₁) receive an acknowledgement of the relocation request. Particularly, event 4-5 shows the target RNC sending the old SGSN a forward relocation request acknowledgement, whereas event 4-6 shows the old SGSN sending a relocation command to the source RNC.

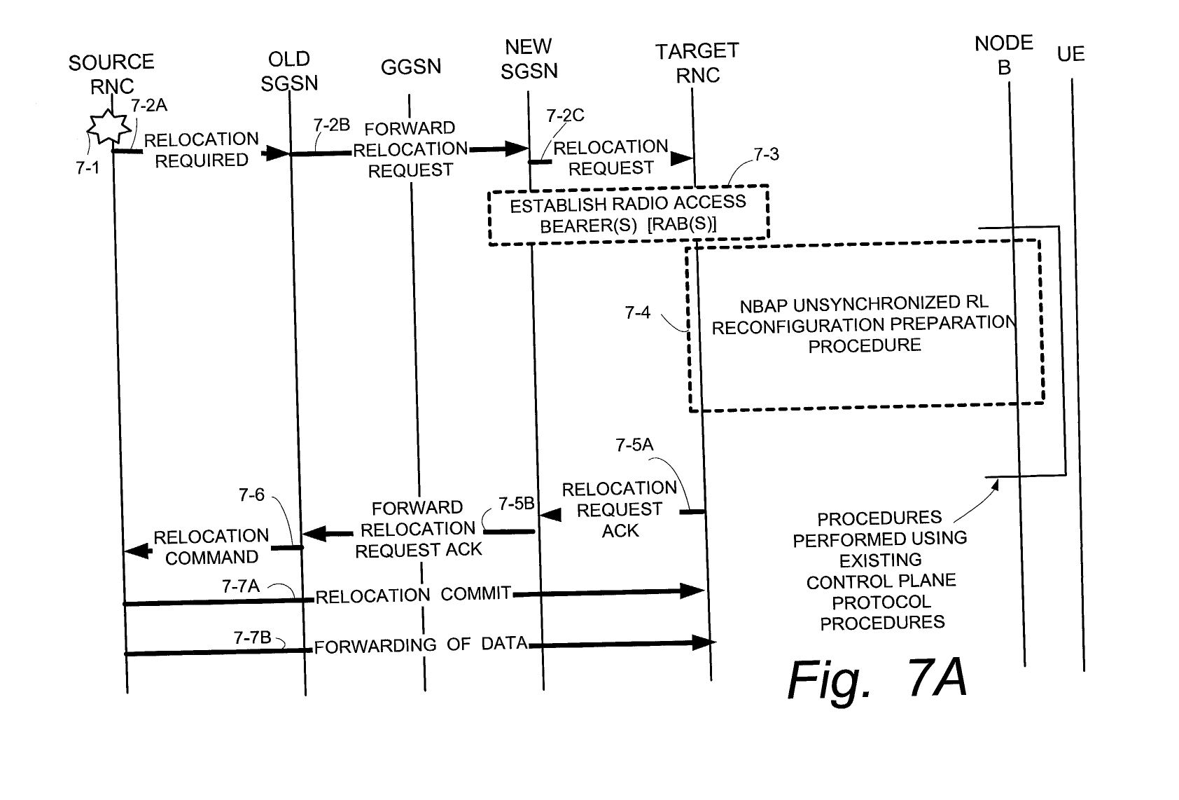

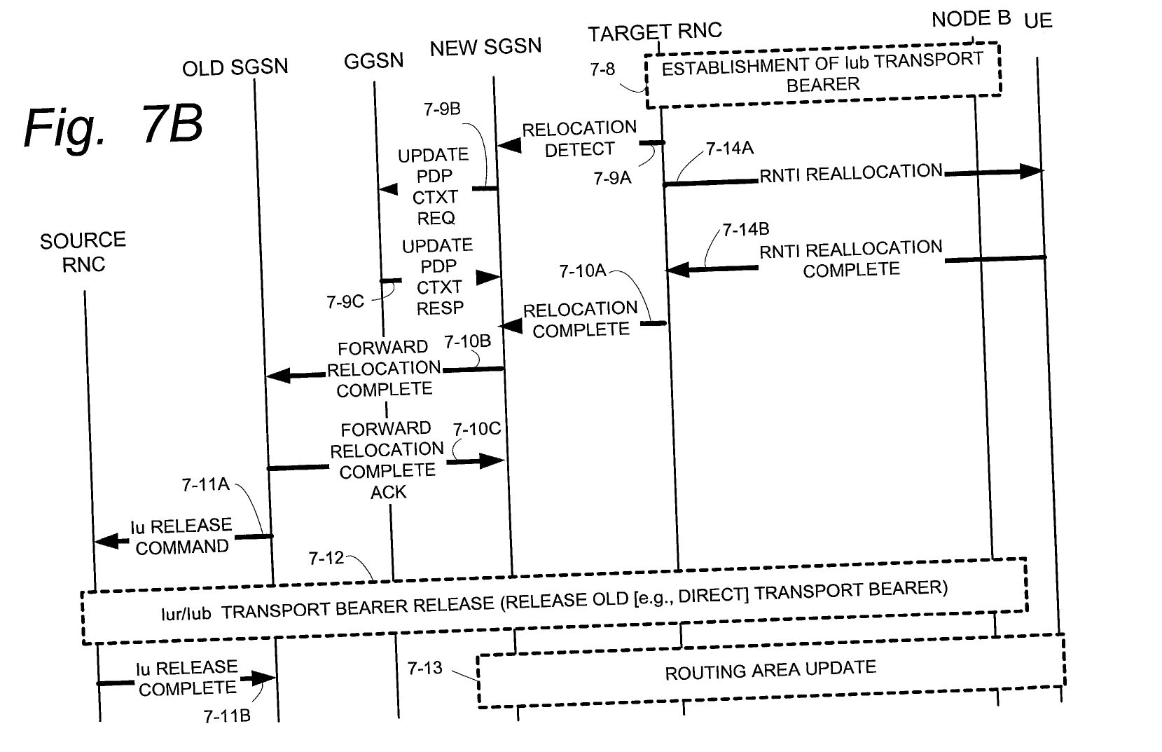

Upon receipt of the relocation command, the source RNC (e.g., radio network controller (RNC) 26₁) launches a relocation triggering process which is depicted as event 4-7 in FIG. 7. This event 4-7, also referred to as a relocation triggering step, includes a relocation execution trigger message sent from the source radio network controller to the target radio network controller. Upon receipt of the relocation execution trigger message, a transport bearer switching process (shown as event 4-8 in FIG. 4) occurs. In the transport bearer switching step, a switch occurs from the old transport bearer (e.g., direct transport bearer 100 in the foregoing example) to the new transport bearer which was established as event 4-4. The transport bearer switching step (event 4-8) is advantageously accomplished in the present invention using existing =control plane protocol(s).

After the transport bearer switching of event 4-8, a relocation detect and PDP context updating process occurs. The relocation detect of event 4-9 involves the target radio network controller and the new SGSN (e.g., Serving GPRS Support Nodes (SGSN) 20₂ in FIG. 2B); the PDP context updating involves the new SGSN and the GGSN (e.g., Gateway GRPS support node (GGSN) 19 in FIG. 2B).

After completion of the PDP context updating, a relocation complete notification is forwarded (event 4-10) from the target RNC to the old SGSN, and (as event 4-11) the old SGSN issues an Iu release command to the source radio network controller. Thereafter, as event 4-12, a procedure is performed for releasing the old transport bearer (e.g., the direct transport bearer 100 in FIG. 2A).

Although FIG. 4 depicts an example mode of SRNS relocation, it should be understood that the representative actions corresponding to the example numbered events of the FIG. 4 mode do not, in more specific implementations, necessarily occur in the same order or sequence as shown in FIG. 4. For example, the new transport bearer establishing step need not necessarily occur at the time shown as event 4-4 in FIG. 4, but (as explained with respect to subsequent implementations) may occur at other times, e.g., after transmission of a relocation execution trigger message.

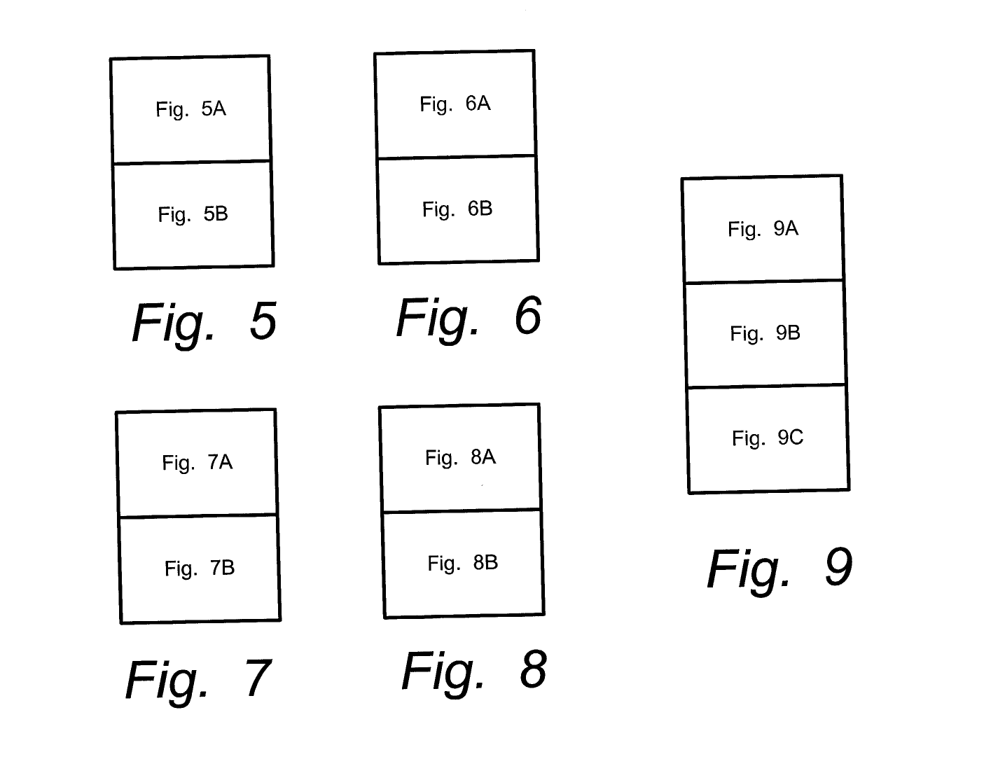

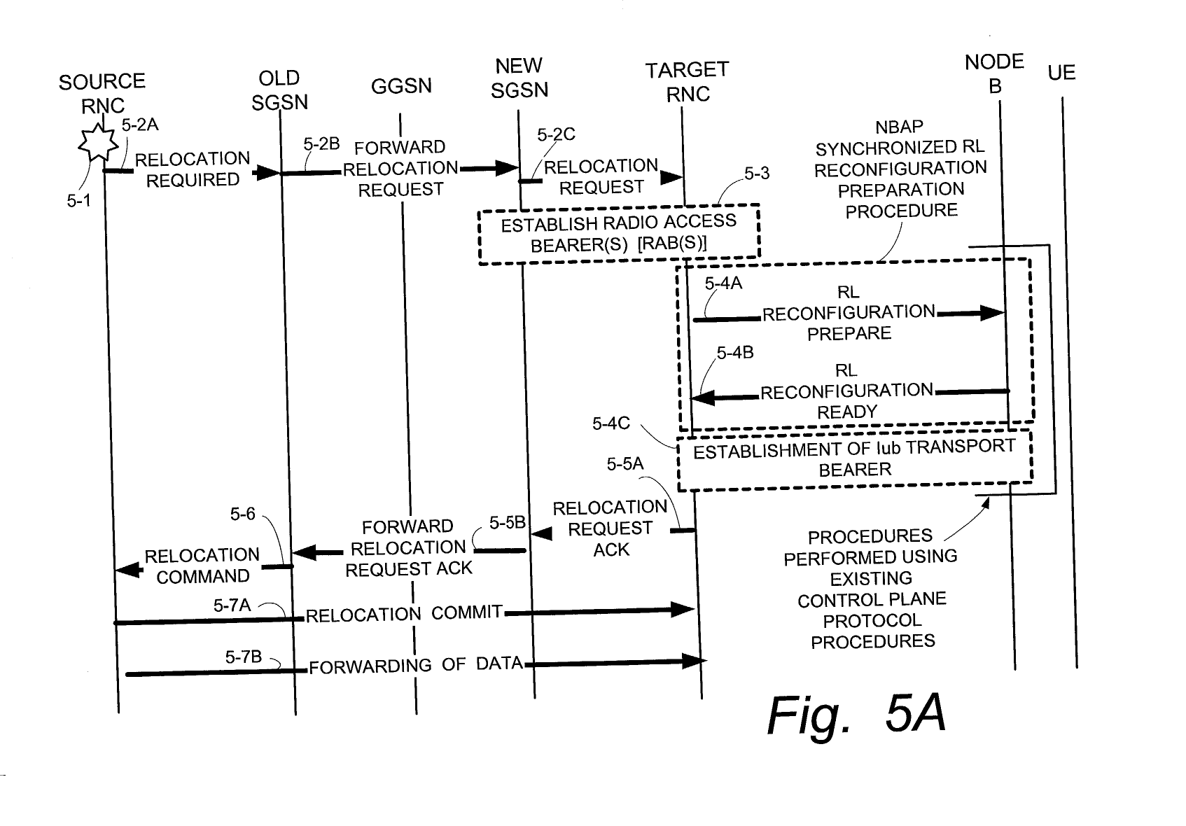

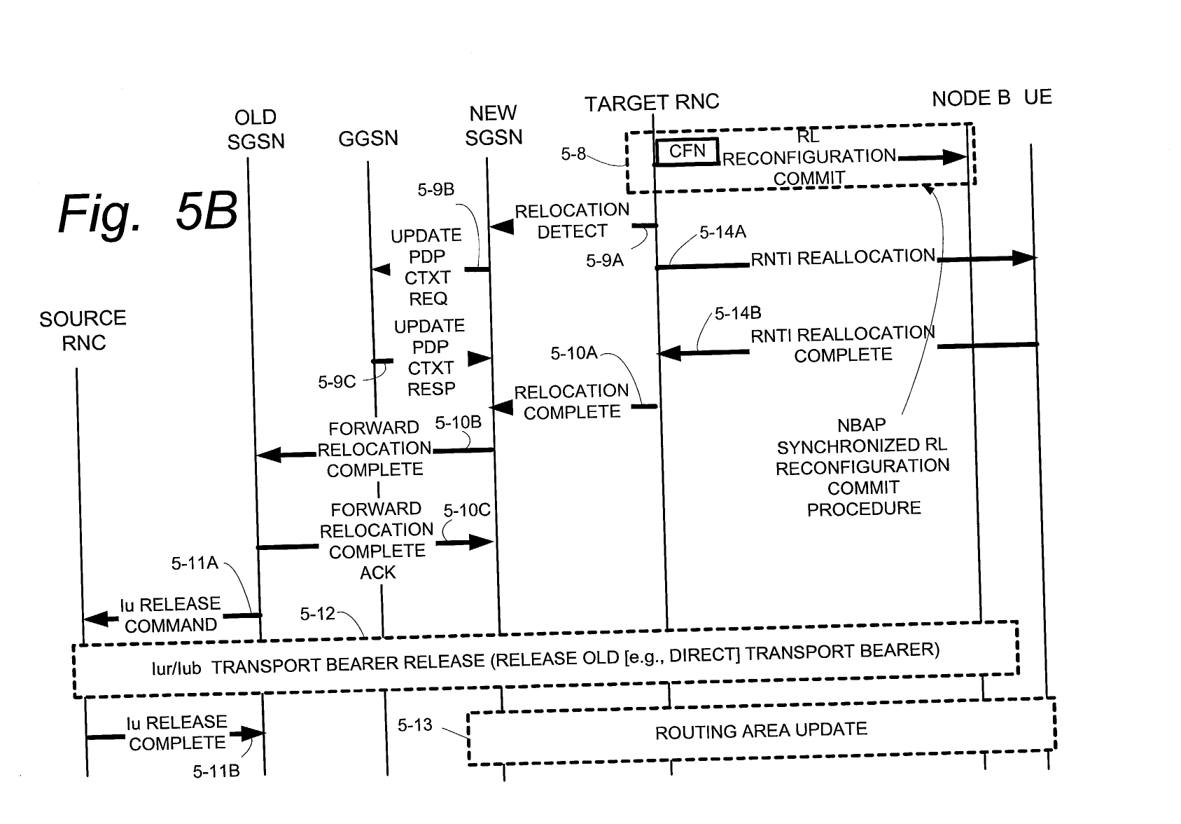

FIG. 5A and FIG. 5B show a first example, non-limiting implementation of the generic mode of FIG. 4. In FIG. 5A and FIG. 5B, like other figures subsequently discussed, reference numerals which have suffixes analogous to those of FIG. 4 refer to analogous events. FIG. 5A represents the new bearer establishing step as comprising event 5-4A through event 5-4C, all such events being procedures which are performed using existing control plane protocol procedures.

For example, event 5-4A comprises a message sent from the target radio network controller (e.g., radio network controller (RNC) 26₂) to the Node-B (e.g., Node-B 28₂₋₁). The message of event 5-4A is also known as a radio link (RL) reconfiguration prepare message. The radio link (RL) reconfiguration prepare message of event 5-4A requests the Node-B to reserve resources for the reconfigured RL (e.g., indicates that a new transport bearer is required), and includes the new radio link parameters. If the Node-B can make these reservations, the Node-B replies with the RL reconfiguration ready message of event 5-4B. The RL reconfiguration ready message of event 5-4B includes the parameters which the target radio network controller can use for establishing the new transport bearer.

With the parameters signaled in the RL reconfiguration ready message of event 5-4B, the target RNC (e.g., radio network controller (RNC) 26₂ in FIG. 2B) is able to initiate establishment of the new transport bearer. Event 5-4C of FIG. 5A reflects generally establishment of the Iub transport bearer. The Iub transport bearer of event 5-4C includes a transport bearer establish request message from the target radio network controller to the Node-B, as well as a transport bearer establish confirm message returned by the Node-B to the target radio network controller. After establishment of the Iub transport bearer, the target radio network controller knows that it can switch to the new transport bearer at any time.

The protocol utilized for establishment of the Iub transport bearer can vary. In one 3GPP specification, the suggested protocol is Q.aal2 signaling. Q.aal2 signaling is described, e.g., in AAL Type 2 Signalling Protocol (Capability Set 1), ITU-T Recommendation Q.2630.1 (1999).

Thus, in the new transport bearer establishing step (see event 5-4A through event 5-4C), the target RNC attempts to reserve the UTRAN resources required after the SRNC relocation. As part of this reservation, the new transport bearer(s) is established towards the Node-B. The Node-B will generally not be aware that these new transport bearers are established from a radio network controller which is other than the radio network controller having the old transport bearer(s). The Node-B can detect that another transport layer address for the radio network controller is utilized, but such could also occur as the result of one radio network controller using multiple transport layer addresses. When the UTRAN resources are successfully reserved, both on the transport layer and the radio network layer, the target radio network controller will transmit the relocation request acknowledge to the new SGSN (e.g., Serving GPRS Support Nodes (SGSN) 20₂ in FIG. 2B) [event 5-5A].

In the FIG. 5A/FIG. 5B implementation, the relocation execution triggering step takes the form of a RNSAP relocation commit message shown as event 5-7A. Upon receipt of the RNSAP relocation commit message, the target radio network controller executes a synchronized RL reconfiguration commit procedure which encompasses the bearer switching step of the invention. The synchronized RL reconfiguration commit procedure utilizes a RL reconfiguration commit message (event 5-8) which carries, either explicitly or implicitly, an indication of a time at which both the target radio network controller and the Node-B will start to use the new transport bearer. Thus, the synchronized RL reconfiguration commit procedure causes the Node-B to switch over to the new transport bearer(s).

Since the user equipment unit (UE) may be moving and additional changes may be required to a group of radio links currently involved in a radio connection towards a certain user equipment unit (UE), it is important that the switch to the new transport bearer be made as soon as possible. To facilitate the switch, in one aspect of the present invention, the RL reconfiguration commit message of event 5-8 can include a connection frame number (CFN) which indicates a specific frame at the Uu interface at which the switchover to the new transport bearer is to occur. The NBAP synchronized RL reconfiguration commit procedure illustrated, e.g., in FIG. 5B, encompasses the switchover from the old transport bearer (which may be the direct transport bearer 100 of FIG. 2A) to the new transport bearer (e.g., to the situation of FIG. 2B).

When the transport bearer replacement (e.g., switchover) has been executed successfully, the target radio network controller sends a relocation detect message (event 5-9A) to the new SGSN 20₂.

Events shown in FIG. 5A and FIG. 5B but not specifically discussed above are understood with reference to the generic mode of FIG. 4 and reference to the general prior art SRNS relocation procedure. It is assumed that the Node-B (under the target radio network controller) need not be aware of the executed Serving SRNS relocation. As reflected by event 5-12, the old transport bearer (e.g., direct transport bearer 100) is released by the source radio network controller (e.g., radio network controller (RNC) 26₁). The releasing of the old transport bearer involves both transmission of a transport bearer release request message from the source radio network controller to the Node-B, and receipt of a transport bearer release confirm message at the target radio network controller from the Node-B. Subsequently a routing area update (event 5-13) is performed.

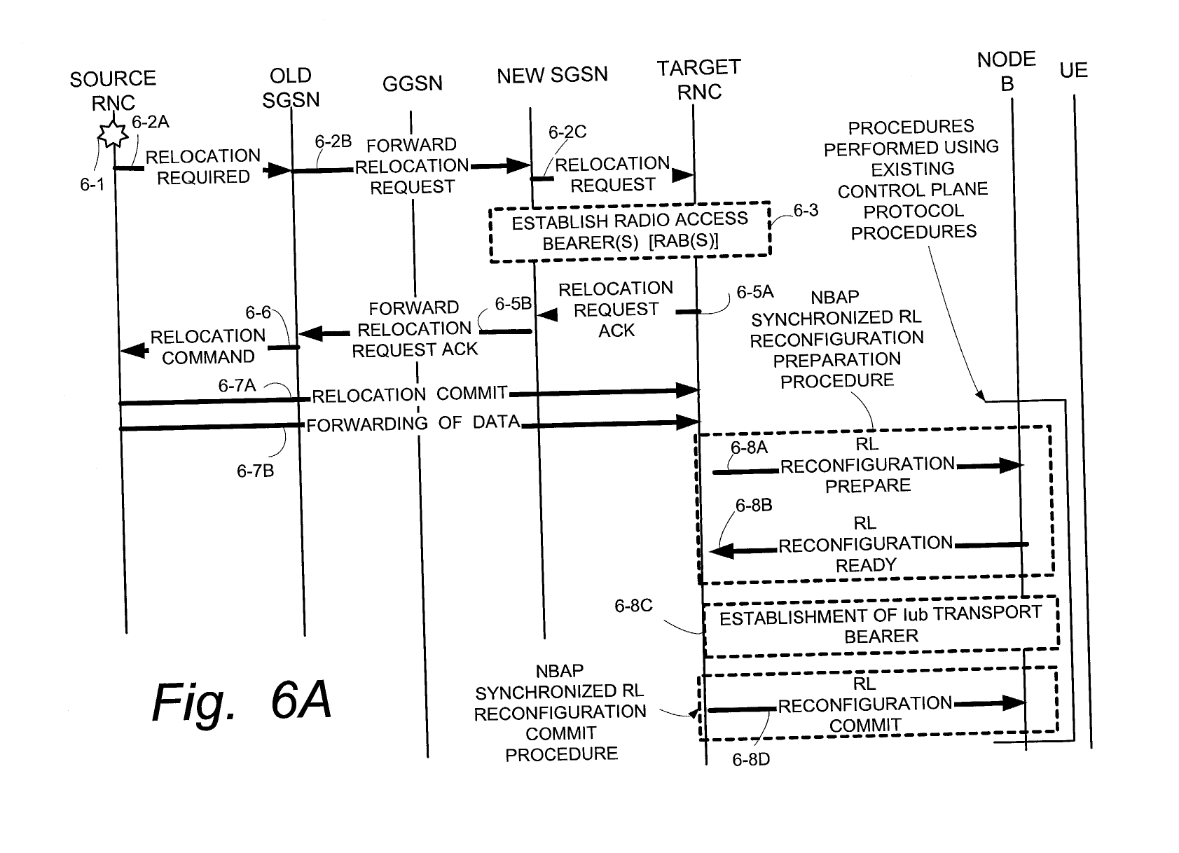

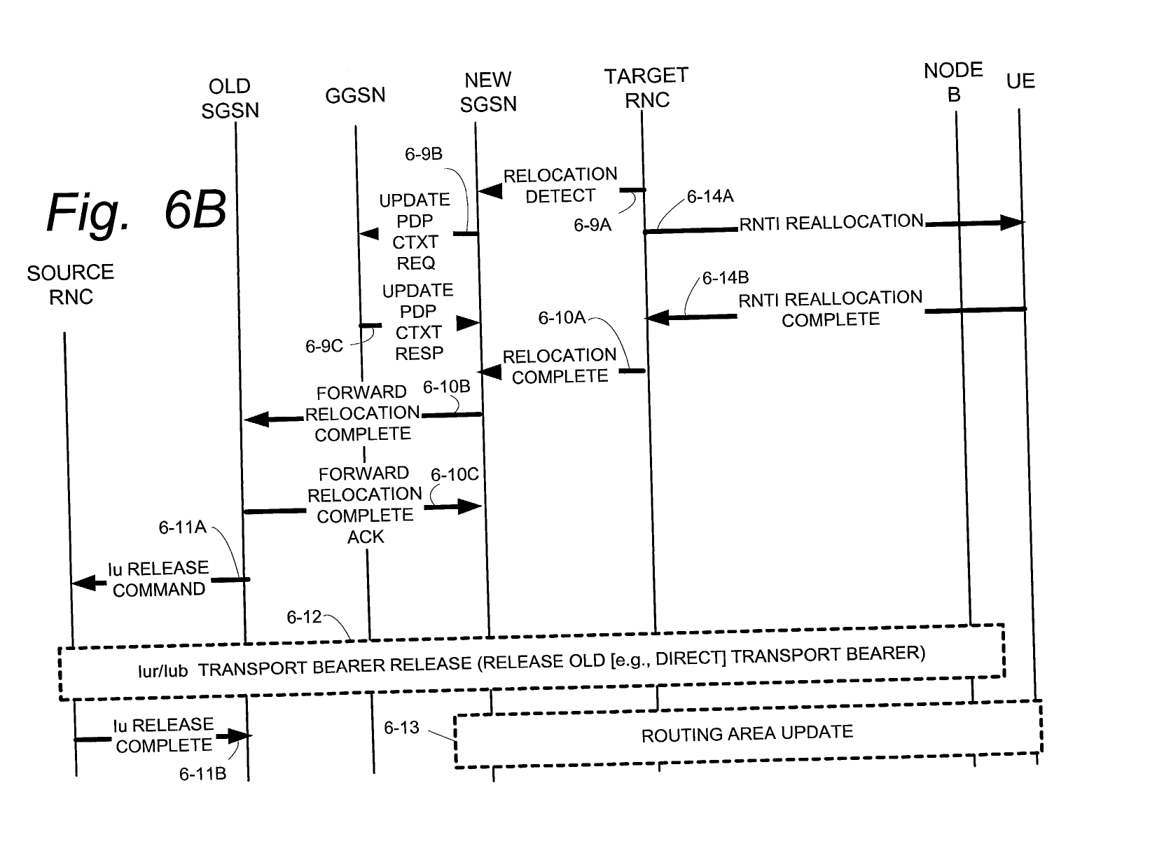

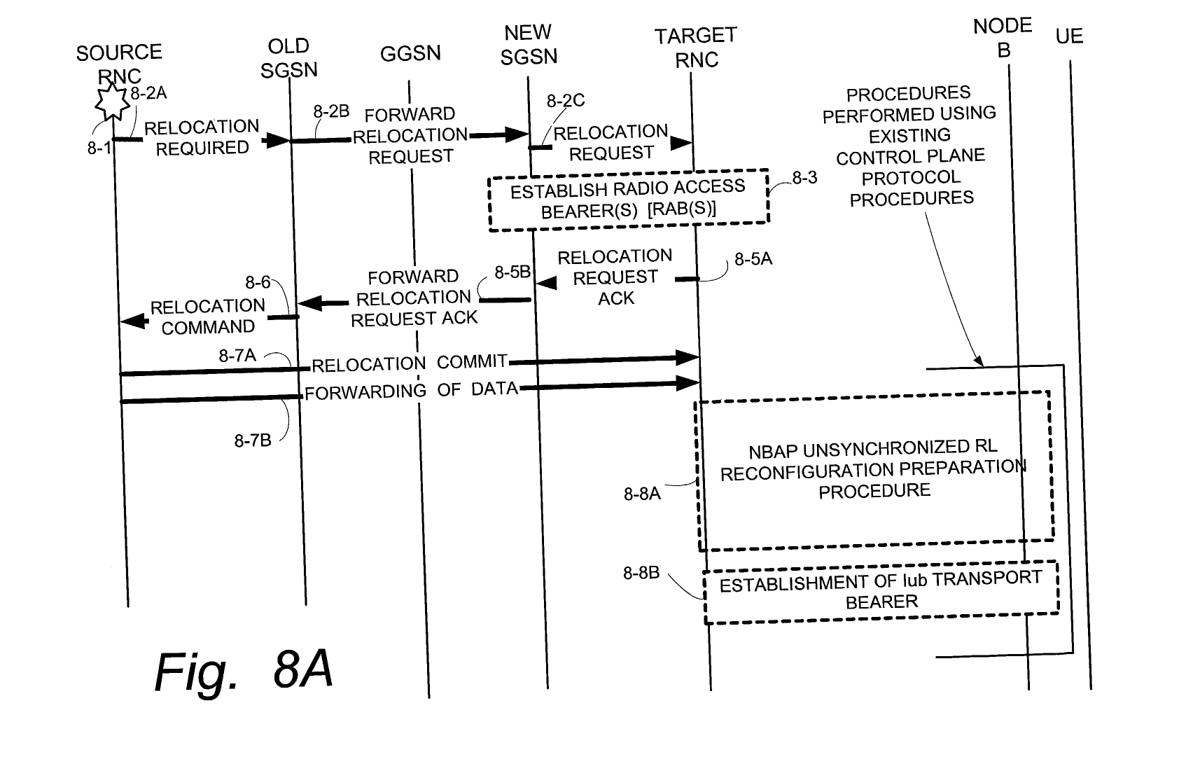

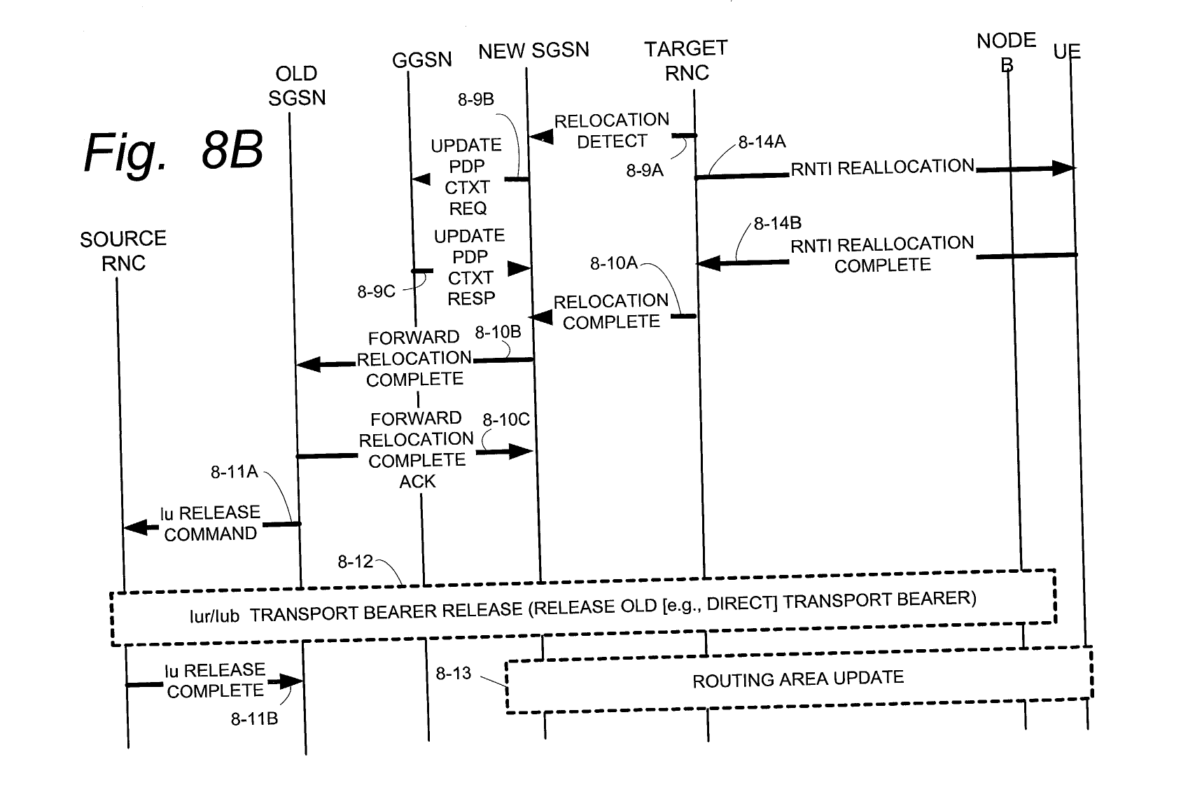

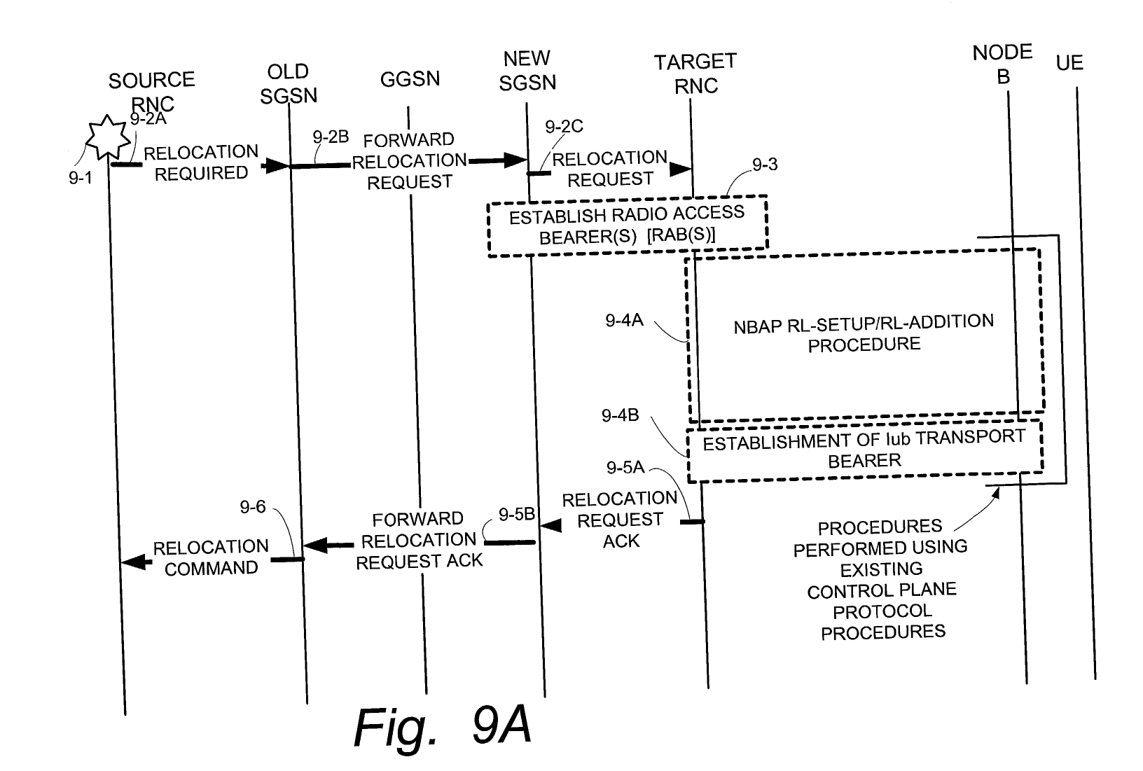

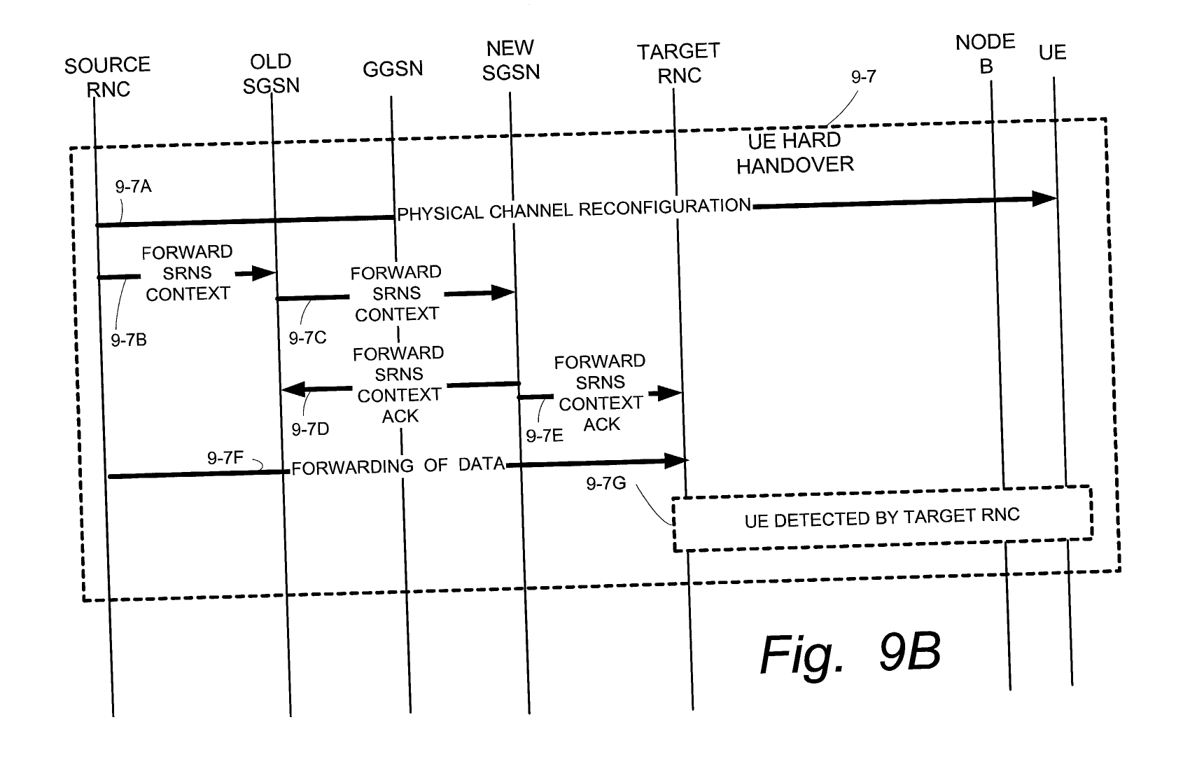

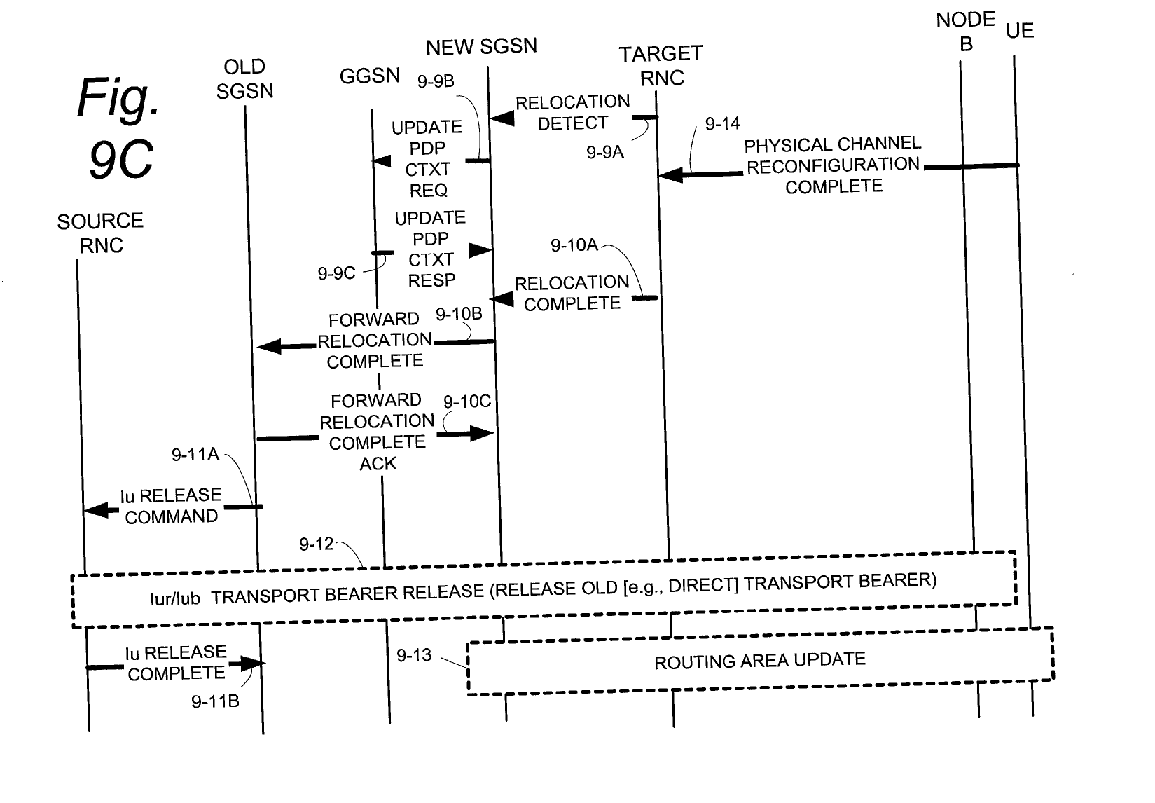

Those skilled in the art will appreciate that the example implementation of FIG. 5A/FIG. 5B is only a non-constraining example, and that other implementations of the generic mode are also possible in the overall SRNS relocation message sequence or using other control plane/user plane triggers for performing the switch. Such other implementations can be achieved by various techniques, such as, e.g., varying message sequences, using the NBAP/RNSAP unsynchronized radio link reconfiguration procedure rather than the NBAP/RNSAP synchronized radio link reconfiguration procedure, and initiating the different NBAP messages at differing positions in the overall SRNS relocation message sequence. Some other example implementations are discussed briefly below with reference to the implementations of FIG. 6A/FIG. 6B; FIG. 7A/FIG. 7B; FIG. 8A/FIG. 8B; and FIG. 9A/FIG. 9B/FIG. 9C. In these other depicted example implementations, reference numerals which have suffixes analogous to those of FIG. 4 again refer to analogous events.

In the implementation of FIG. 6A/FIG. 6B, the new transport bearer(s) is established after the triggering step, with the new transport bearer establishing step and the bearer switching step together involving: (1) performing a NBAP synchronized radio link reconfiguration procedure; (2) establishing a new transport bearer; and (3) performing a NBAP synchronized radio link reconfiguration commit procedure. Specifically, FIG. 6A shows that the NBAP synchronized radio link reconfiguration preparation procedure follows the relocation commit message of event 6-7A (e.g., the triggering step). Further, the NBAP synchronized radio link reconfiguration preparation procedure includes the radio link reconfiguration prepare message (event 68A) and the radio link reconfiguration ready message (event 6-8B), both of which have previously been discussed. Establishment of the Iub transport bearer is reflected by event 6-8C, while implementation of the radio link reconfiguration commit procedure is shown to include transmitting the RL reconfiguration commit message (event 6-8D). In other respects, the FIG. 6A/FIG. 6B implementation essentially resembles that of FIG. 5A/FIG. 5B.

In both the implementation of FIG. 7A/FIG. 7B and the implementation of FIG. 8A/FIG. 8B, a NBAP unsynchronized radio link reconfiguration procedure is utilized. For example, in the implementation of FIG. 7A/FIG. 7B the NBAP unsynchronized radio link reconfiguration procedure is performed prior to the relocation triggering and the transport bearer establishing occurs after the relocation triggering. Specifically, in the implementation of FIG. 7A/FIG. 7B the NBAP unsynchronized radio link reconfiguration procedure is performed as event 7-4, which precedes the relocation commit message (the triggering step) of event 7-7A. Upon receipt of the relocation commit message, the new transport bearer is established (event 7-8). Since the radio link reconfiguration procedure is unsynchronized, the actual switchover to the new transport bearer can occur at any time. For example, the switchover to the new transport bearer can occur immediately upon establishment of the new transport bearer, as is current practice with the unsynchronized radio link reconfiguration procedure. However, alternate switchover timings are also envisioned, such as (for example) switchover when a data frame is received by the node-B with a valid timing. For example, the node-B can start using the new transport bearer for the transport of UL data frames from the CFN for which it has received the first DL data frame before LTOA (last time of arrival). Every data frame is labeled with a CFN (connection frame number) at which it needs to be sent out at the radio interface. Since the processing capabilities of the Node-B are not endless, the Node-B will have to receive the data frame a certain time before the radio frame labeled with that CFN really starts. This time will allow the Node-B to perform this processing. If the Node-B receives a frame before LTOA, it means that it will still have sufficient time to process it and send it out on the radio interface. This is also an indication to the Node-B that the RNC is in control of the timing so it is a good moment to switch to the new bearer.

In the implementation of FIG. 8A/FIG. 8B the NBAP unsynchronized radio link reconfiguration procedure is performed (along with the establishing of the new transport bearer) subsequent to the relocation triggering. Specifically, FIG. 8A shows that the NBAP unsynchronized radio link reconfiguration procedure is performed as event 8-8A, and is followed by establishment of the Iub transport bearer (event 8-8C). Both event 8-8A and event 8-8B are preceded by the relocation commit procedure (event 8-7A).

The implementations of FIG. 7A/FIG. 7B and FIG. 8A/FIG. 8B have a potential drawback in that the target radio network controller has no guarantee that the target radio network controller can obtain all necessary resources when sending the relocation request acknowledge message [see event 7-5A in FIG. 7A and event 8-5A in FIG. 8A] to the new SGSN (e.g., new SGSN 20₂ in FIG. 2B). On the other hand, taking an unsynchronized approach does not require the CFN estimate and could overall result in a faster transport bearer replacement. It is noted that in all cases the target radio network controller will have to find out the detailed timing of the user plane over the Iub interface. If the radio network controller is not able to make a sufficient timing estimate based on available timing information, finding out the timing on the user plane will require at least the exchange of one data frame/timing adjustment control frame.

In yet another example implementation shown in FIG. 9A/FIG. 9B/FIG. 9C, the new transport bearer is established by performing one of a NBAP radio link setup procedure and a NBAP radio link addition procedure, after which a user equipment unit (UE) hard handover is performed for bearer switching. FIG. 9A shows one of a NBAP radio link setup procedure and a NBAP radio link addition procedure as being performed as event 9-4A, followed by establishment of the Iub new transport bearer (event 9-4B). Subsequently a UE hard handover is performed as event 9-7.

For the most part, all of the preceding example implementations, except the FIG. 9A/FIG. 9B/FIG. 9C implementation, pertain to the Serving SRNS relocation procedure which is the first case described in 3GPP Technical Specification TS 23.060 (as mentioned above). The example implementation shown in FIG. 9A/FIG. 9B/FIG. 9C differs from the preceding alternatives, in that the implementation shown in FIG. 9A/FIG. 9B/FIG. 9C is handled as a combined hard handover and SRNS relocation procedure (the second 3GPP TS 23.060 case). The implementation shown of FIG. 9A/FIG. 9B/FIG. 9C also requires other changes to the message sequence. Some of these changes are shown as part of the UE hard handover event 9-7.

Instead of a non-UE involved solution, in the implementation of FIG. 9A/FIG. 9B/FIG. 9C the user equipment unit (UE) is involved and performs a hard handover to the new radio links. The new radio links could all be established in the same cells as the radio links which were used by the user equipment unit (UE) before the SRNS relocation, or could (partially) also concern other cells. One way of accomplishing this is to have the target radio network controller make a choice whether the target radio network controller wants to continue the SRNS relocation with a UE-not involved alternative or with a UE-involved alternative. The source radio network controller would be informed about such choice, e.g., based on the presence of an RRC message in the RANAP relocation command message. This way of accomplishing this alternative requires a change to the RANAP protocol, since currently according to the RANAP protocol the source radio network controller decides the relocation type (e.g., whether UE-involved or not UE-involved).

In one of its aspects, the invention also encompasses transmitting a trigger value to Node-B to indicate to Node-B when the switching from the direct transport bearer to the new transport bearer is to occur. In one example embodiment, the trigger value is the connection frame number (CFN), discussed above, which denotes a specific frame at a radio interface.

If the target radio network controller has not kept track of the CFN on the radio connection to the user equipment unit (UE), the target radio network controller will have to set an appropriate CFN. By just using a random value, the transport bearer replacement might, in the worst case, take up to 2.56 seconds. Regarding the target radio network controller setting an appropriate CFN value, the target radio network controller was informed of the frame and chip offset of the CFN towards the System Frame Number (SFN) of the cell when the radio link was originally established. By remembering these offsets, and keeping track of the SFN of the cell (which the radio network controller will normally do for transmission on, e.g., PCH/FACH channels), the target radio network controller will be able to determine a CFN value which will take place in the near future and use this CFN value in the radio link reconfiguration commit message, thereby minimizing the service interruption. Alternatively, in combination with the unsynchronized radio link reconfiguration, sending a data frame with a valid timing on each new transport bearer will result in an immediate switchover.

Several other modifications can be considered for implementations such as those discussed above. Some of these modifications may require a change to current specifications. For example, as a first modification, the current synchronous radio link reconfiguration commit procedures can be adapted or replaced such that the CFN no longer needs to be included, and absence of the CFN would be interpreted as meaning to switch “as soon as possible”. Another such modification is to include a CFN in the RNSAP relocation commit message which would enable the target radio network controller and the source radio network controller both to be aware in detail of the moment in time at which the target radio network controller would take over the communication on the radio interface.

Advantageously, the present invention utilizes existing NBAP/RNSAP/RSNAP procedures during SRNS relocation for replacing an old (existing) transport bearer with a new transport bearer, and result in moving the transport bearer to another RNC. Moreover, this occurs without the Node-B necessarily being aware of the fact that it will have a connection to a different radio network controller after the SRNS relocation. Moreover, the SRNS relocation of the present invention is feasible when the old transport bearer was a direct transport bearer between the source radio network controller and the Node-B.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. For use in a telecommunications radio access network wherein a connection with a user equipment unit (UE) is controlled by a source radio network controller, the connection involving the user equipment unit (UE) being in radio communication with a Node-B, the Node-B being controlled by a target radio network controller, a method comprising:
(1) utilizing a direct transport bearer between the source radio network controller and the Node-B, the source radio network controller performing a serving radio network controller (SRNS) function for the connection; and then
(2) performing a SRNS relocation procedure to relocate the SRNS function from the source radio network controller to the target radio network controller, and including, in the SRNS relocation procedure, a message of an existing control plane protocol procedure to establish a new transport bearer between the target RNC and the Node-B.

2. The method of claim 1, wherein the existing control plane protocol procedure includes at least one of a NBAP procedure and a RNSAP procedure.

3. The method of claim 1, wherein the step of performing the SRNS relocation procedure further comprises:
(A) communicating to the target radio network controller that a relocation of the SRNS function is requested;
(B) establishing the new transport bearer between the target radio network controller and the Node-B;
(C) sending a relocation execution trigger message from the source radio network controller to the target radio network controller; and
(D) switching from the direct transport bearer to the new transport bearer.

4. The method of claim 3, wherein the step of performing the SRNS relocation procedure further comprises:
(E) releasing the direct transport bearer.

5. The method of claim 3, wherein step (B) and step (D) employ steps of a radio link reconfiguration procedure(s).

6. The method of claim 5, further comprising using a NBAP synchronized radio link reconfiguration procedure.

7. The method of claim 3, wherein the relocation execution trigger of step (C) is a RNSAP relocation commit message.

8. The method of claim 3, wherein step (D) includes using a synchronized radio link reconfiguration commit procedure to make the Node-B switch over to the new transport bearer.

9. The method of claim 3, wherein step (B) is performed after step (C).

10. The method of claim 9, wherein step (B) and step (D) together include:
performing a NBAP synchronized radio link reconfiguration preparation procedure;
establishing a new transport bearer; and
performing a NBAP synchronized radio link reconfiguration commit procedure.

11. The method of claim 9, further comprising performing a NBAP unsynchronized radio link reconfiguration procedure.

12. The method of claim 11, further comprising performing step (D) immediately upon establishing the new transport bearer.

13. The method of claim 11, further comprising performing step (D) when a data frame with a valid timing is received on the new transport bearer at the Node-B.

14. The method of claim 11, further comprising performing the NBAP unsynchronized radio link reconfiguration procedure prior to performing step (C).

15. The method of claim 14, further comprising performing step (D) immediately upon establishing the new transport bearer.

16. The method of claim 14, further comprising performing step (D) when a data frame with a valid timing is received on the new transport bearer at the Node-B.

17. The method of claim 3, wherein step (B) includes performing one of a NBAP radio link setup procedure and a NBAP radio link addition procedure; and wherein step (D) includes performing a user equipment unit (UE) hard handover.

18. The method of claim 3, wherein step (D) includes transmitting a trigger value to the Node-B to indicate to the Node-B when the switching from the direct transport bearer to the new transport bearer is to occur.

19. The method of claim 18, wherein the trigger value is a connection frame number (CFN) which denotes a specific frame at a radio interface.

20. The method of claim 18, wherein the trigger value is also transmitted to the source radio network controller in a RNSAP relocation commit procedure.

21. The method of claim 3, wherein step (D) includes the target radio network controller indicating that the switching from the direct transport bearer to the new transport bearer is to occur as soon as possible.

22. The method of claim 21, wherein step (D) includes the target radio network controller indicating, by absence of a trigger value, that the switching from the direct transport bearer to the new transport bearer is to occur as soon as possible.

23. For use in a telecommunications radio access network wherein a connection with a user equipment unit (UE) is controlled by a source radio network controller, the connection involving the user equipment unit (UE) being in radio communication with a node-B, the Node-B being controlled by a target radio network controller, a method comprising utilizing a radio link reconfiguration procedure to provide a new transport bearer between the target radio network controller and the Node-B when performing a SRNS relocation procedure to relocate a SRNS function from the source radio network controller to the target radio network controller.

24. The method of claim 23, wherein the step of performing the SRNS relocation procedure further comprises:
(A) communicating to the target radio network controller that a relocation of the SRNS function is requested;
(B) establishing the new transport bearer between the target radio network controller and the Node-B;
(C) sending a relocation execution trigger message from the source radio network controller to the target radio network controller; and
(D) switching from an old transport bearer to the new transport bearer.

25. The method of claim 24, wherein the step of performing the SRNS relocation procedure further comprises:
(E) releasing the old transport bearer.

26. The method of claim 24, wherein step (B) and step (D) employ steps of a radio link reconfiguration procedure.

27. The method of claim 24, wherein the relocation execution trigger of step (C) is a RNSAP relocation commit message

28. The method of claim 24, wherein step (D) includes using a synchronized radio link reconfiguration commit procedure to make the Node-B switch over to the new transport bearer.

29. The method of claim 24, wherein step (B) is performed after step (C).

30. The method of claim 29, wherein step (B) and step (D) together include:
performing a NBAP synchronized radio link reconfiguration preparation procedure;
establishing a new transport bearer; and
performing a NBAP synchronized radio link reconfiguration commit procedure.

31. The method of claim 29, and further comprising performing a NBAP unsynchronized radio link reconfiguration procedure.

32. The method of claim 31, further comprising performing step (D) immediately upon establishing the new transport bearer.

33. The method of claim 31, further comprising performing step (D) when a data frame with a valid timing is received on the new transport bearer at the Node-B.

34. The method of claim 29, further comprising performing the NBAP unsynchronized radio link reconfiguration procedure prior to performing step (C).

35. The method of claim 34, further comprising performing step (D) immediately upon establishing the new transport bearer.

36. The method of claim 34, further comprising performing step (D) when a data frame with a valid timing is received on the new transport bearer at the Node-B.

37. The method of claim 24, wherein step (B) includes performing one of a NBAP radio link setup procedure and a NBAP radio link addition procedure; and wherein step (D) includes performing a user equipment unit (UE) hard handover.

38. The method of claim 24, wherein step (D) includes transmitting a trigger value to the Node-B to indicate to the Node-B when the switching from the direct transport bearer to the new transport bearer is to occur.

39. The method of claim 34, wherein the trigger value is a connection frame number (CFN) which denotes a specific frame at a radio interface.

40. The method of claim 34, wherein the trigger value is also transmitted to the source radio network controller in a RNSAP relocation commit procedure.

41. The method of claim 24, where step (D) includes the target radio network controller indicating that the switching from the old transport bearer to the new transport bearer is to occur as soon as possible.

42. The method of claim 41, where step (D) includes the target radio network controller indicating, by absence of a trigger value, that the switching from the old transport bearer to the new transport bearer is to occur as soon as possible.

43. A telecommunications radio access network comprising:
a Node-B in radio communication with a user equipment unit (UE);
a target radio network controller which controls the Node-B;
a source radio network controller which, prior to performance of a SRNS relocation procedure, performs a serving radio network controller (SRNS) function for a connection and controls the connection with the user equipment unit (UE), the connection involving a direct transport bearer between the source radio network controller and the Node-B;
wherein when performing the SRNS relocation procedure to relocate the SRNS function from the source radio network controller to the target radio network controller, the radio access network utilizes an existing control plane protocol procedure to establish a new transport bearer between the target radio network controllers and the Node-B.

44. The apparatus of claim 35, wherein the existing control plane protocol procedure includes at least one of a NBAP procedure and a RNSAP procedure.

45. The apparatus of claim 35, wherein:
the source radio network controller communicates to the target radio network controller that a relocation of the SRNS function is requested;
the target radio network controller and the Node-B cooperate to establish the new transport bearer between the target radio network controller and the Node-B;
the source radio network controller sends a relocation execution trigger message to the target radio network controller; and
the target radio network controller and the Node-B switch from the direct transport bearer to the new transport bearer.

46. The apparatus of claim 37, wherein the source radio network controller releases the direct transport bearer.

47. The apparatus of claim 37, wherein the target radio network controller and the Node-B cooperate to establish a new transport bearer between the target radio network controller and the Node-B using a radio link reconfiguration procedure.

48. The apparatus of claim 37, wherein the source radio network controller sends a relocation execution trigger message to the target radio network controller using a RNSAP relocation commit message.

49. The apparatus of claim 37, wherein the target radio network controller and the Node-B switch from the direct transport bearer to the new transport bearer using a synchronized radio link reconfiguration commit procedure.

50. The apparatus of claim 37, wherein the target radio network controller and the Node-B cooperate to establish a new transport bearer between the target radio network controller and the Node-B after the source radio network controller sends a relocation execution trigger message to the target radio network controller.

51. The apparatus of claim 37, wherein the relocation execution trigger message indicates that the switching from the direct transport bearer to the new transport bearer is to occur as soon as possible.

52. The apparatus of claim 51, wherein the relocation execution trigger message indicates, by absence of a trigger value, that the switching from the direct transport bearer to the new transport bearer is to occur as soon as possible.
